(19) United States
(12) Patent Application Publication
(10) Pub. No.: US 2024/0126248 A1
(43) Pub. Date: Apr. 18, 2024

(54) METHOD AND SYSTEM FOR ANALYZING STABILITY OF FACTORY ENERGY CONSUMPTION BASED ON ENERGY INTENSITY PER PRODUCT

(71) Applicant: ELECTRONICS AND TELECOMMUNICATIONS RESEARCH INSTITUTE, Daejeon (KR)

(72) Inventors: Jihyun LEE, Daejeon (KR); IL Woo LEE, Daejeon (KR)

(21) Appl. No.: 18/379,745

(22) Filed: Oct. 13, 2023

(30) Foreign Application Priority Data
Oct. 18, 2022 (KR) 10-2022-0134351

(51) Int. Cl. G05B 19/418

(52) U.S. Cl. CPC G05B 19/41875; G05B 19/4183; G05B 2219/23102

(57) ABSTRACT

Provided is a method and a system for analyzing stability of factory energy consumption based on energy intensity per product. The method includes extracting a profile including a production history of a product and process operation information of a process line or process equipment used to produce the product, determining energy intensity per product, which is a ratio of an amount of energy consumed to produce the product for production of the product, based on the profile, and identifying consumption stability of energy consumed to produce the product based on the energy intensity per product.

### CROSS-REFERENCE TO RELATED APPLICATION

This application claims the benefit of Korean Patent Application No. 10-2022-0134351 filed on Oct. 18, 2022, in the Korean Intellectual Property Office, the entire disclosure of which is incorporated herein by reference for all purposes.

### BACKGROUND

### 1. Field of the Invention

One or more embodiments relate to a method and a system for analyzing factory energy consumption stability, and to a method and a system for analyzing whether energy used to operate a production process to produce a product is stably consumed in a factory in terms of product production.

### 2. Description of Related Art

Even when producing the same product item with the same process equipment in a factory, the difference in the production quantity and the amount of consumed energy exists due to influence from a production equipment operation and management. Accordingly, there is a need for a method of determining whether energy used in a production process is being stably consumed in terms of product production. Here, intensity has been used as an indicator to evaluate the efficiency of energy that is input to the economic activities of a country. The larger the intensity value, the more inefficient energy is used.

The “energy intensity by product” used to produce a product in a factory is a numerical expression of the calories (kilocalorie (Kcal) and/or kilogram (Kg)) required to produce 1 Kg of a certain product, and the energy intensity by product is widely used to indicate an energy efficiency goal to save the amount of energy consumed in a factory.

The method of determining energy intensity according to the related art is calculated by measuring the total energy consumption used in a production process, an energy consumption equipment, and an energy activity in a factory, a large building, and a country with high energy consumption.

However, since the method of determining energy intensity according to the related art determines only energy intensity for a factory, a large building, and the entire country, it is impossible to determine energy intensity for each product or to analyze elements that may save energy based on intensity.

Accordingly, in most factories, a method of calculating the energy intensity consumed by each product is being requested so that a detailed analysis and an improvement plan for elements that may analyze the energy intensity consumed in a factory by each product and save energy can be derived from a corresponding process, main equipment, and an equipment operation.

### SUMMARY

Embodiments provide a method and a system for analyzing consumption stability of energy used to produce a product in a factory through continuous monitoring and a comparison analysis of a determination value of the energy intensity per product.

According to an aspect, there is provided a method of analyzing energy consumption stability including extracting a profile including a production history of a product and process operation information of a process line or process equipment used to produce the product, determining energy intensity per product, which is a ratio of an amount of energy consumed to produce the product for production of the product, based on the profile, and identifying consumption stability of energy consumed to produce the product based on the energy intensity per product.

The method may further include performing pre-processing to extract the profile and setting a comparison period to generate comparative intensity to be compared with the energy intensity per product.

The identifying of the consumption stability may include determining comparative consumption energy intensity based on a profile extracted for the comparison period, comparing the comparative consumption energy intensity with the energy intensity per product, and identifying the consumption stability according to a comparison result.

The performing of the pre-processing may include selecting the product, setting process hierarchy structure information for each process line that produces the product, setting process-measurement point mapping information to extract measurement information collected from a point of an activity device or a processing machine designated as an analysis target in a process activity that produces the product, and setting analysis time information, which is a time interval to extract the profile among pieces of time information from a time the product started to be produced to a time production of the product is completed.

The extracting of the profile may include extracting a production profile of a production period including a production history of the product, determining whether production amount is measurable in the process line or each of processes, extracting production information of the process line by measuring production amount of the process line when production amount is measurable in the process line, extracting production information of each of the processes by measuring production amount of the process line when production amount is measurable in each of the processes, and extracting product amount during an analysis period as total product production based on the production information of the process line or the production information of each of the processes. The extracting of the profile may further include determining whether a process interruption history exists during the production period based on the production profile, extracting, as production information, information on a type of a product produced in the process line or the process equipment, a detailed specification of the product, and production of the process line or the process equipment during the production period, when the process interruption history does not exist, and extracting, as production information, information on a type of a product produced in the process line or the process equipment, a detailed specification of the product, and production of the process line or the process equipment during a normal operation period in which a process abnormality or a process interruption does not occur, when the process interruption history exists.

The method may further include determining whether steam energy intensity calculation is required, determining whether electrical energy intensity calculation is also required when the steam energy intensity calculation is required, and determining whether the electrical energy intensity calculation is required when the steam energy intensity calculation is not required. The determining of the energy intensity per product may include determining at least one of steam energy intensity and electrical energy intensity by performing at least one of the steam energy intensity calculation and the electrical energy intensity calculation.

The determining of the energy intensity per product may include extracting a supply flow rate supplied to each of process lines when determining the steam energy intensity for the process line, calculating a total supplied steam amount for the process line based on a supply flow rate used in each of the process lines during a normal operation period in which a process abnormality or a process interruption does not occur, and determining the steam energy intensity of the process line based on the total supplied steam amount and of the process line and total product production.

The determining of the energy intensity per product may include extracting electricity supply supplied to each of the process lines when determining the electrical energy intensity for the process line, calculating total electricity supply for the process lines based on electricity supply used in each of the process lines during a normal operation period in which a process abnormality or a process interruption does not occur, and determining the electrical energy intensity of the process line based on the total electricity supply of the process line and total product production.

The determining of the energy intensity per product may include extracting a supply flow rate supplied to each of processes when determining the steam energy intensity for each of processes in the process line, calculating a total supplied steam amount for the process based on a supply flow rate used in each of the processes during a normal operation period in which a process abnormality or a process interruption does not occur, and determining the steam energy intensity of the process based on the total supplied steam amount of the process and total product production.

The determining of the energy intensity per product may include extracting electricity supply supplied to each of processes when determining the electrical energy intensity for each of processes in the process line, calculating total electricity supply for the process based on electricity supply used in each of the processes during a normal operation period in which a process abnormality or a process interruption does not occur, and determining the electrical energy intensity of the process based on the total electricity supply of the process and total product production.

According to another aspect, there is provided a system for analyzing energy consumption stability including a profile extraction module configured to extract a profile including a production history of a product and process operation information of a process line or process equipment used to produce the product, an intensity determiner configured to determine energy intensity per product, which is a ratio of an amount of energy consumed to produce the product for production of the product, based on the profile, and an energy consumption instability identifier configured to identify consumption stability of energy consumed to produce the product based on the energy intensity per product.

The profile extraction module may be configured to set a comparison period to generate comparative intensity to be compared with the energy intensity per product, and the energy consumption instability identifier may be configured to determine comparative consumption energy intensity based on a profile extracted for the comparison period, compare the comparative consumption energy intensity with the energy intensity per product, and identify the consumption stability according to a comparison result.

The profile extraction module may be configured to extract a production profile of a production period including a production history of the product, determine whether a process interruption history exists during the production period based on the production profile, extract, as production information, information on a type of a product produced in the process line or the process equipment, a detailed specification of the product, and production of the process line or the process equipment during the production period, when the process interruption history does not exist, and extract, as production information, information on a type of a product produced in the process line or the process equipment, a detailed specification of the product, and production of the process line or the process equipment during a normal operation period in which a process abnormality or a process interruption does not occur, when the process interruption history exists.

The intensity determiner may be configured to determine whether steam energy intensity calculation is required and determine whether electrical energy intensity calculation is also required when the steam energy intensity calculation is required, determine whether the electrical energy intensity calculation is required when the steam energy intensity calculation is not required, and determine at least one of steam energy intensity and electrical energy intensity by performing at least one of the steam energy intensity calculation and the electrical energy intensity calculation.

The intensity determiner may be configured to extract a supply flow rate supplied to each of the process lines when determining the steam energy intensity for the process line, calculate a total supplied steam amount for the process line based on a supply flow rate used in each of the process lines during a normal operation period in which a process abnormality or a process interruption does not occur, and determine the steam energy intensity of the process line based on the total supplied steam amount of the process line and total product production.

The intensity determiner may be configured to extract electricity supply supplied to each of the process lines when determining the electrical energy intensity for the process line, calculate total electricity supply for the process line based on electricity supply used in each of the process lines during a normal operation period in which a process abnormality or a process interruption does not occur, and determine the electrical energy intensity of the process line based on the total electricity supply of the process line and total product production.

The intensity determiner may be configured to extract a supply flow rate supplied to each of processes when determining the steam energy intensity for each of processes in the process line, calculate a total supplied steam amount for the process based on a supply flow rate used in each of the processes during a normal operation period in which a process abnormality or a process interruption does not occur, and determine the steam energy intensity of the process based on the total supplied steam amount of the process and total product production.

The intensity determiner may be configured to extract electricity supply supplied to each of processes when determining the electrical energy intensity for each of processes in the process line, calculate total electricity supply for the process based on electricity supply used in each of the processes during a normal operation period in which a process abnormality or a process interruption does not occur, and determine the electrical energy intensity of the process based on the total electricity supply of the process and total product production.

Additional aspects of embodiments will be set forth in part in the description which follows and, in part, will be apparent from the description, or may be learned by practice of the disclosure.

According to embodiments, it may be seen that consumption energy used to operate a production process to produce a product is stably consumed in a factory in terms of product production by analyzing consumption stability of energy used to produce a product in a factory through continuous monitoring and a comparison analysis of a determination value of the energy intensity per product.

According to embodiments, it is possible to identify whether an energy consumption abnormality exists from a production profile and a process operation profile when a sudden drop or a sudden rise occurs of an intensity value by observing consistence of an intensity value per product.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a system for analyzing stability of factory energy consumption according to an embodiment;

FIG. 2 is a diagram illustrating a hierarchy structure of a process line, a process, process equipment, and a process activity, according to an embodiment;

FIG. 3 is a diagram illustrating an example of a normal process and a process interruption according to an embodiment;

FIG. 4 is a diagram illustrating a detailed configuration of a profile extraction module of a system for analyzing stability of factory energy consumption, according to an embodiment;

FIG. 5 is a flowchart illustrating a method for analyzing stability of factory energy consumption according to an embodiment;

FIG. 6 is a flowchart illustrating a process of performing pre-processing of a method for analyzing stability of factory energy consumption, according to an embodiment;

FIG. 7 is a flowchart illustrating a process of extracting a profile of a method for analyzing stability of factory energy consumption, according to an embodiment;

FIG. 8 is a flowchart illustrating a process of determining energy intensity per product of a method for analyzing stability of factory energy consumption, according to an embodiment;

FIG. 9 is a flowchart illustrating a process of performing electrical energy intensity calculation for a process line in a process of determining energy intensity per product, according to an embodiment;

FIG. 10 is a flowchart illustrating a process of performing steam energy intensity calculation for a process line in a process of determining energy intensity per product, according to an embodiment;

FIG. 11 is a flowchart illustrating a process of performing electrical energy intensity calculation for each of processes in a process of determining energy intensity per product, according to an embodiment; and

FIG. 12 is a flowchart illustrating a process of performing steam energy intensity calculation for each of processes in a process of determining energy intensity per product, according to an embodiment.

### DETAILED DESCRIPTION

Hereinafter, embodiments will be described in detail with reference to the accompanying drawings. According to an embodiment, a method for analyzing stability of factory energy consumption may be performed by a system for analyzing stability of factory energy consumption.

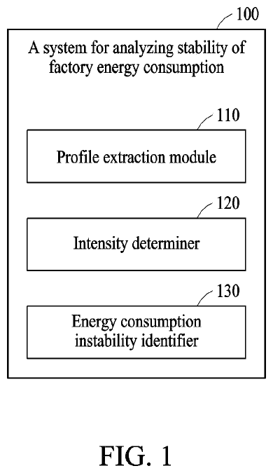

FIG. 1 is a diagram illustrating a system for analyzing stability of factory energy consumption according to an embodiment.

A system for analyzing stability of factory energy consumption 100 may calculate the energy intensity used as a factory energy consumption key performance indicator and identify the abnormality of the energy intensity per product when an outlier on the intensity pattern occurs by monitoring whether the energy intensity is maintained, whether the energy intensity increases and/or decreases, or a sudden rise and/or a sudden drop occurs. Here, since the energy intensity is measured by the amount of energy required per unit production output or activity, when the energy used to produce a product decreases, the energy intensity may also decrease.

Here, the energy intensity per product may be a ratio of the amount of energy consumed to produce a certain product during the process of product production. In addition, the system for analyzing stability of factory energy consumption 100 may determine that the energy consumption used to produce a product is stable when the energy intensity per product is maintained within a certain acceptable range.

As shown in FIG. 1, the system for analyzing stability of factory energy consumption 100 may include a profile extraction module 110, an intensity determiner 120, and an energy consumption instability identifier 130. Here, as shown in FIG. 1, the profile extraction module 110, the intensity determiner 120, and the energy consumption instability identifier 130 may be different processors or respective modules in a program executed by one processor.

The profile extraction module 110 may extract, from an information collection system, a production profile for a production history producing a product during a predetermined product production period and a process operation profile including process operation information of a process line or process equipment used to produce the product. In addition, the profile extraction module 110 may perform pre-processing to extract a profile. In addition, the profile extraction module 110 may set a comparison period to generate the comparative intensity to be compared with the energy intensity per product. For example, the production profile may include at least one of a production date, a production time (e.g., a start time and a completion time), a product name, a detailed product specification, and production information. In addition, the process operation profile may include at least one of a process job and process operation information for each time. Here, the process operation information for each time may be a value (e.g., equipment status information, equipment failure, energy consumption amount, or process interruption) measured in a process line and process equipment while a process is performed by unit time (e.g., second unit or minute unit).

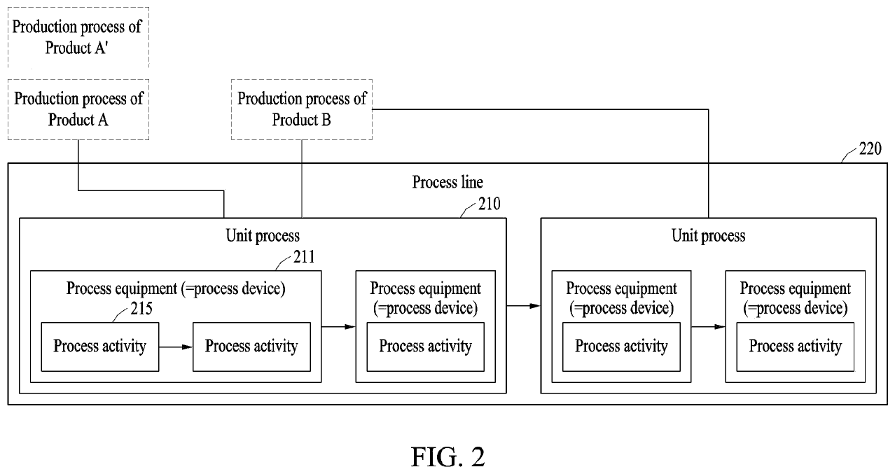

The intensity determiner 120 may determine the energy intensity per product, which is a ratio of the amount of energy consumed to produce a product during the process of product production, based on a profile extracted by the profile extraction module 110. Here, the intensity determiner 120 may determine the intensity by selecting the classification of the production equipment used to produce a product by a process line or an individual process. In addition, the process may be formed of a series of production activities in which an input resource is changed to a product and the process line may mean that processes to produce a product are consecutively disposed according to the process order. The relationship between the process and process line is described in detail below with reference to FIG. 2.

Here, the intensity determiner 120 may determine whether steam energy intensity calculation is required. When the steam energy intensity calculation is required, the intensity determiner 120 may determine whether electrical energy intensity calculation is also required.

When the steam energy intensity calculation is required but the electrical energy intensity calculation is not required, the intensity determiner 120 may determine steam energy intensity by performing the steam energy intensity calculation. When the steam energy intensity calculation and the electrical energy intensity calculation are required, the intensity determiner 120 may determine the steam energy intensity by performing the steam energy intensity calculation and determine the electrical energy intensity by performing the electrical energy intensity calculation.

When the steam energy intensity calculation is not required, the intensity determiner 120 may determine whether the electrical energy intensity calculation is required. When the electrical energy intensity calculation is not required, the intensity determiner 120 may terminate the operation. In addition, when the electrical energy intensity calculation is required, the intensity determiner 120 may determine the electrical energy intensity by performing the electrical energy intensity calculation.

That is, according to an embodiment, the intensity determiner 120 may determine steam energy intensity for steam consumption or electrical energy intensity for electricity consumption for each process line or each process.

For example, when determining the steam energy intensity for the process line, the intensity determiner 120 may extract a supply flow rate supplied to each of the process lines. Next, the intensity determiner 120 may identify an abnormal operation period from the start time to the end time when a process abnormality and/or a process interruption occurs from the process operation profile. In addition, the intensity determiner 120 may calculate the production itself supply flow for the energy consumed in the process line only to produce a product based on the supply flow rate used in each of the process lines during a normal operation period in which a process abnormality or a process interruption does not occur except for an abnormal operation period in the entire time period. Next, the intensity determiner 120 may determine the steam energy intensity of the process line based on the steam supply flow rate of the process line and the total product amount from production itself.

In addition, when determining the electrical energy intensity for the process line, the intensity determiner 120 may extract the electricity supply supplied to each of the process lines. Next, the intensity determiner 120 may calculate the total electricity supply for the process line based on the electricity supply used in each of the process lines during a normal operation period in which a process abnormality or a process interruption does not occur. Next, the intensity determiner 120 may determine the electrical energy intensity of the process line based on the total electricity supply amount of the process line and the total product amount.

In addition, when determining the steam energy intensity for each of the processes in the process line, the intensity determiner 120 may extract the supply flow rate supplied to each of the processes. Next, the intensity determiner 120 may calculate the total supplied steam amount for the process based on the supply flow rate used in each of the processes during a normal operation period in which a process abnormality or a process interruption does not occur. Next, the intensity determiner 120 may determine the steam energy intensity of the process based on the total supplied steam amount of the process and the total product amount.

In addition, when determining the electrical energy intensity for each of the processes in the process line, the intensity determiner 120 may extract the supply power supplied to each of the processes. Next, the intensity determiner 120 may calculate the total electricity supply amount for the process based on the supply power used in each of the processes during a normal operation period in which a process abnormality or a process interruption does not occur. Next, the intensity determiner 120 may determine the electrical energy intensity of the process based on the total supplied electricity amount of the process and the total product production.

The energy consumption instability identifier 130 may identify the consumption stability of energy consumed to produce a product based on the energy intensity per product determined by the intensity determiner 120. Here, the energy consumption instability identifier 130 may determine the comparative consumption energy intensity based on an extracted profile for a comparison period. Next, the energy consumption instability identifier 130 may compare the comparative consumption energy intensity with the energy intensity per product. Here, the energy consumption instability identifier 130 may identify the consumption stability of energy according to a comparison result.

Here, the energy consumption instability identifier 130 may compare two energy intensities for the same type of energy consumption (e.g., electricity and electricity or steam and steam) and set one as the reference intensity, which is a comparison standard, and the other one as the intensity calculated at the current time and/or the recent time compared with the reference intensity. For example, when comparing the intensity for the same type and/or different types of products, the energy consumption instability identifier 130 may first compare the difference between the energy intensity consumed to produce product A with the energy intensity consumed to produce product A′ and secondarily determine whether the energy intensity for the product A′ is in the critical range of A′. The energy intensity of the product A′ being less than or equal to the critical range of A′ means a state in which the product amount is higher than usual while the energy consumption pattern is similar to usual or lower than usual, which may be regarded as a stable and good state of the energy consumption. Accordingly, the energy consumption instability identifier 130 may determine that the energy consumption to produce a product is stable. However, since there is a possibility that an energy consumption observed value is inaccurately measured due to a measurement error, the energy consumption instability identifier 130 may inspect whether the observed value has an error.

However, since the intensity of the product A′ being greater than or equal to the critical range of A′ means a state in which the energy consumption is increased compared to the product production, the energy consumption instability identifier 130 may inspect an observed value during the process operation to determine whether an energy consumption status abnormality occurs.

In addition, even though the similarity of the comparative process operation condition is greater than or equal to a certain range, when the energy intensity per product exceeds the critical range showing a significant difference from the energy intensity per product, which is a comparison standard, the energy consumption instability identifier 130 may determine that the instability occurs in the energy consumption to produce a product. The energy intensity per product is an indicator that shows whether much energy or less energy to produce the same product is consumed. When the same product is produced, when the energy intensity per product is higher than at other time, it may be seen that the cause for increasing the unit price of a product produced during the corresponding period occurs. Accordingly, the energy consumption instability identifier 130 may compare energy intensity AA for a certain product with energy intensity BB determined by the comparison standard and evaluate the rise, consistence, or drop of the intensity from the AA and BB under the condition of consuming the same type of energy source.

That is, the energy consumption instability identifier 130 may identify the decrease and/or increase in the amount of energy consumed when producing a certain product according to the comparison result, the efficiency of consumption energy, and the operational difference of the certain product production process. In addition, the energy consumption instability identifier 130 may analyze the usage efficiency of energy consumed in the production process as a numerical value using the identification result to identify energy saving elements consumed to produce a product, determine key saving points, and determine saving effects.

In addition, the energy consumption instability identifier 130 may analyze by combining operational status data of the process with the product production information to analyze whether the product production in the production profile is the production during an abnormal operation period of the process in the process operation profile. In addition, the energy consumption instability identifier 130 may recalculate the normal product amount by excluding the amount produced during the time from the process operation start time to the end time during which problems, such as process abnormality and interruption occurs.

The system for analyzing stability of factory energy consumption 100 may determine whether the consumption energy used to perform the production process to produce a product in the factory is being consumed stably in terms of product production by analyzing the consumption stability of consumption energy used to produce a product in a factory through continuous monitoring and comparison analysis according to the determination value of energy intensity per product.

In addition, the system for analyzing stability of factory energy consumption 100 may continuously monitor the energy intensity per product and observe a sudden drop, sudden rise, or consistence of the intensity. Here, the sudden drop information and/or the sudden rise information may mean that a change occurred in the amount of energy consumed to produce a product or the product amount. Accordingly, when a sudden drop or a sudden rise in the intensity occurs, the system for analyzing stability of factory energy consumption 100 may identify whether an energy consumption abnormality from the production profile and the process operation profile exists.

FIG. 2 is a diagram illustrating a hierarchy structure of a process line, a process, process equipment, and a process activity, according to an embodiment.

A process activity 215 may be a series of production activities in which an input material is changed to a product. In addition, process equipment 211 may be hardware and a machine on which the process activity 215 is performed. In addition, a unit process 210 may include the process activities 215 performed in at least one piece of process equipment 211.

In addition, a process line 220 may mean that the unit process 210 to produce a product and the process equipment 211 performing the unit process 210 are consecutively assembled and disposed according to the process order. Here, the unit processes 210 in the process line 220 may be classified according to a unit that calculates energy consumption.

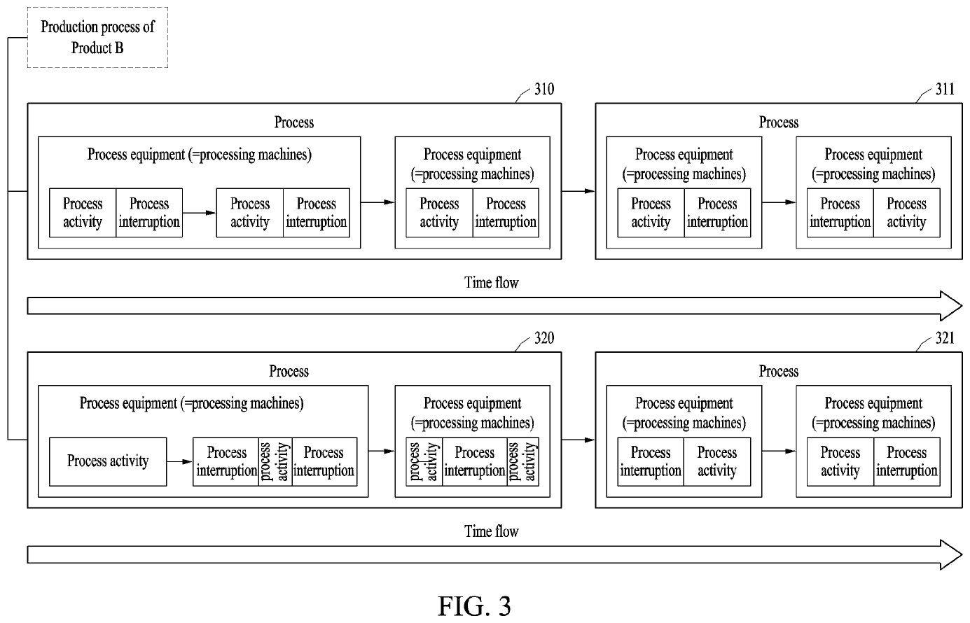

FIG. 3 is a diagram illustrating an example of a normal process and a process interruption according to an embodiment.

As shown in FIG. 3, process equipment in a process 310 may interrupt a process activity in the middle or later of the production period. However, as shown in FIG. 3, a process 320 performing the same process activity as the process 310 may interrupt a process activity in the middle of the production period or may not interrupt the process activity as the process activity is normally performed. Hereinafter, a profile extraction module of a system for analyzing stability of factory energy consumption may operate in the same way even when the section indicated as a process interruption is regarded as a process abnormality in

FIG. 3.

In addition, as shown in FIG. 3, a process 311 and a process 321 performing the same process activity may have different periods during which the processes are interrupted for the production.

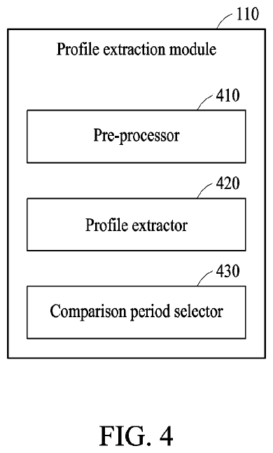

FIG. 4 is a diagram illustrating a detailed configuration of a profile extraction module of a system for analyzing stability of factory energy consumption, according to an embodiment.

As shown in FIG. 4, the profile extraction module 110 may include a pre-processor 410, a profile extractor 420, and a comparison period selector 430. Here, as shown in FIG. 4, the pre-processor 410, the profile extractor 420, and the comparison period selector 430 may be different processors or respective modules in a program executed by one processor.

The pre-processor 410 may perform pre-processing to extract a profile. Here, the pre-processor 410 may select a specific target product to be analyzed for stability of the factory energy consumption. Next, the pre-processor 410 may set structure information about what sub-process elements are hierarchically structured for each process that produces a product. Next, the pre-processor 410 may set process-to-measurement point mapping information to extract measurement information collected from a point of an activity device or a processing machine designated as an analysis target in a process activity that produces a product. Next, the pre-processor 410 may set time range to analyze stability of energy intensity, which is a time interval to extract a profile among pieces of time information from the time a product started to be produced to the time production of a product is completed.

The profile extractor 420 may extract, from an information collection system, a profile including a production history of a product during a production period of the predetermined product and process operation information of a process line or process equipment used to produce a product.

Here, the profile extractor 420 may extract a production profile of a production period including a production history of a product. Next, the profile extractor 420 may determine whether the amount is measurable in the process line or each process. When the product amount is measurable in the process line, the profile extractor 420 may measure the product amount of the process line and extract the production information of the process line. When the product amount is measurable in each process, the profile extractor 420 may measure the product amount of the process equipment in each of the processes and extract the production information of each of the processes. Finally, the profile extractor 420 may extract the product amount during the analysis period as the total product amount based on the production information of the process line or the individual production information of each of the performed processes.

In addition, the profile extractor 420 may determine whether a process interruption history during the production period based on the production profile exists. When the process interruption history does not exist, the profile extractor 420 may extract the following information such as production information about the performed process, information on the type of a product produced in the process line or the process equipment, a detailed specification of the product, and the production of the process line or the process equipment during the production period except for the interruption. In addition, when the process interruption history such as a process interruption or a process abnormality from the performed production exists, the profile extractor 420 may extract, as the production information, the information on the type of product produced in the process line or the process equipment, a detailed specification of the product, and the production of the process line or the process equipment during a normal operation period in which a process interruption or a process abnormality does not occur.

The comparison period selector 430 may set a comparison period to generate comparison standard intensity for a target product to be compared with energy intensity of consumed energy. Here, the intensity, which is a comparison standard, may refer to the same type of product or may refer to energy intensity per product determined by extracting a profile during a comparison period when the consumed energy is the same energy type. For example, the comparison period may be the same month of the previous year, last week on the same production line, last month of this year, same quarter of last year, and the like.

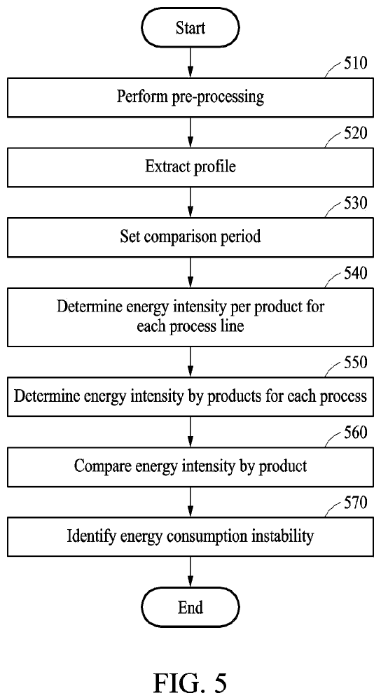

FIG. 5 is a flowchart illustrating a method for analyzing stability of factory energy consumption according to an embodiment.

In operation 510, the profile extraction module 110 may perform pre-processing for the purpose of extracting a profile.

In operation 520, the profile extraction module 110 may extract, from an information collection system, a profile including a production history of a product during a predetermined product production period and process operation information of a process line or process equipment used to produce a product.

In operation 530, the profile extraction module 110 may set a comparison period to generate comparative intensity to be compared with energy intensity per product.

In operation 540, the intensity determiner 120 may determine energy intensity per product for each process line using the profile extracted in operation 530. Here, according to an embodiment, the intensity determiner 120 may determine steam energy intensity for steam consumption or electrical energy intensity for electricity consumption for each process line.

In operation 550, the intensity determiner 120 may determine the energy intensity per product for each process in the process line using the profile extracted in operation 530. Here, the steam energy intensity or the electrical energy intensity for each process may be determined. In addition, according to an embodiment, the order of operations 540 and 550 may be changed and may be performed in parallel, or only one of operations 540 and 550 may be performed.

In operation 560, the energy consumption instability identifier 130 may identify energy consumption stability of consumed energy to produce a product based on the energy intensity per product determined in operations 540 and 550. Here, the energy consumption instability identifier 130 may determine the comparative energy intensity based on the extracted profile for the comparison period. Next, the energy consumption instability identifier 130 may compare the comparative energy intensity with the energy intensity per product. Here, the energy consumption instability identifier 130 may identify whether the energy consumption used for production is stable or unstable according to a comparison result.

In operation 570, the energy consumption instability identifier 130 may analyze whether the product amount in the profile is produced during an abnormal operation of the process.

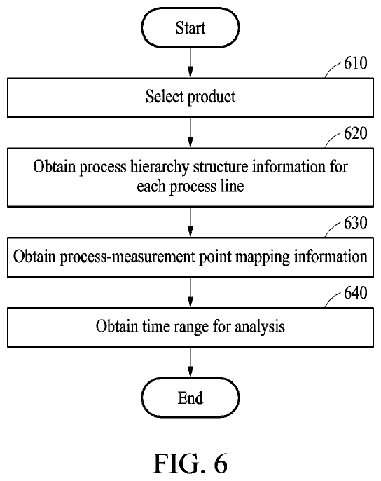

FIG. 6 is a flowchart illustrating a process of performing pre-processing of a method for analyzing stability of factory energy consumption, according to an embodiment. Operations from 610 to 640 of FIG. 6 may be included in operation 510 of FIG. 5.

In operation 610, the pre-processor 410 of the profile extraction module 110 may select a target product to be analyzed for the factory energy consumption stability.

In operation 620, the pre-processor 410 may set process hierarchy structure information for each process line that produces a product. Here, the process hierarchy structure information for each process line may be information indicating that a product selected in operation 610 is produced from which process line and/or process of a factory. For example, the process hierarchy structure information for each process line may be the information as shown in FIG. 2. In addition, the pre-processor 410 may designate, as an analysis range, a process assembly area used to produce the designated product in FIG. 2.

In operation 630, the pre-processor 410 may set process-measurement point mapping information to extract measurement information collected from a point of an activity device or a processing machine designated as an analysis target in a process activity that produces a product.

In operation 640, the pre-processor 410 may set analysis time information, which is a time interval to extract a profile among pieces of time information from the time a product started to be produced to the time production of a product is completed.

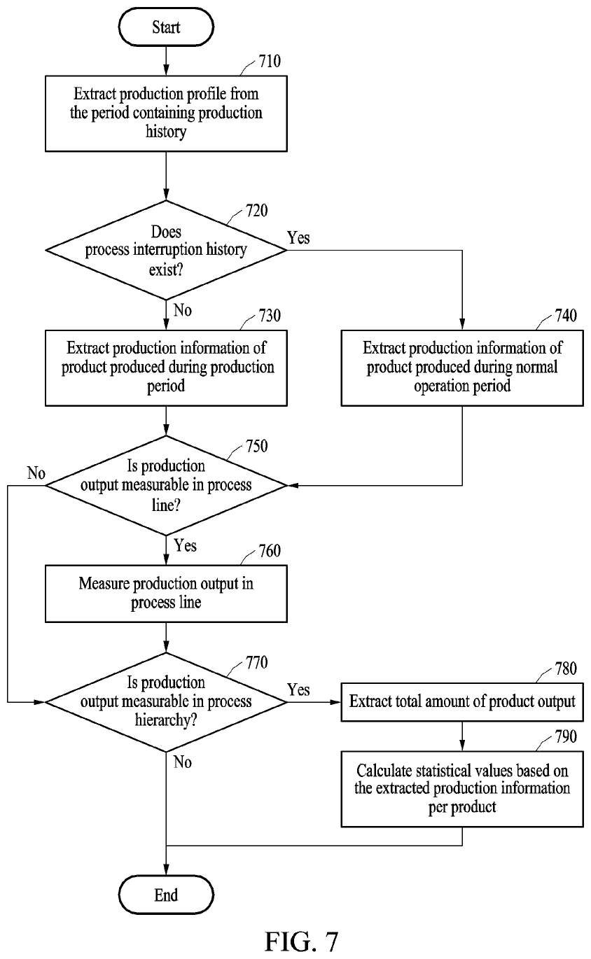

FIG. 7 is a flowchart illustrating a process of extracting a profile of a method for analyzing stability of factory energy consumption, according to an embodiment. Operations from 710 to 790 of FIG. 7 may be included in operation 520 of FIG. 5.

In operation 710, the profile extractor 420 may extract a production profile of a production period including a production history of a product. Here, the profile extractor 420 may integrally inspect conditions on whether there is a production record of the product selected in the pre-processor 410, whether there is production history information limited to the designated product while there is a production record, and how much the amount is produced and may extract the production profile by reflecting the condition inspection result. Here, the production profile may include information on which product is produced from when to when.

In operation 720, the profile extractor 420 may determine whether a process interruption history during the production period exists based on the production profile extracted in operation 710. Here, the profile extractor 420 may inspect whether there is a process interruption history, the duration of the interruption, and the cause of the interruption during the production history of the product.

When the process interruption history exists, the profile extractor 420 may perform operation 740. When the process interruption history does not exist, the profile extractor 420 may perform operation 730.

In operation 730, the profile extractor 420 may extract, as the production information, information on the type of a product produced by a process line or process equipment, a detailed specification of the product, and the product amount of the process line or the process equipment during the production period.

In operation 740, the profile extractor 420 may extract, as the production information, information on the type of a product produced by a process line or process equipment, a detailed specification of the product, and the product amount of the process line or the process equipment during a normal operation period in which a process abnormality or a process interruption does not occur (i.e., the net production process).

In operation 750, the profile extractor 420 may determine whether the product amount is measurable in the process line. Here, the profile extractor 420 may determine whether the analysis range is the process line and whether the product amount is measured at the process line level. When the produced product amount is measurable in the process line, the profile extractor 420 may perform operation 760. When the produced product amount is not measurable in the process line, the profile extractor 420 may perform operation 770. In operation 760, the profile extractor 420 may measure the produced product amount of the process line and extract the production information of the process line.

In operation 770, the profile extractor 420 may determine whether the produced product amount is measurable in each of the processes. Here, the profile extractor 420 may determine whether the produced amount information is analyzed and extracted at the process level forming the process line. When the product amount is measurable in each of the processes, the profile extractor 420 may perform operation 780. When the product amount is not measurable in each of the processes, the profile extractor 420 may terminate the operation.

In operation 780, the profile extractor 420 may measure the product amount of the process equipment in each of the processes and extract the product amount information of each of the processes. Here, the profile extractor 420 may set an analysis period including from the start time to the end time of the product amount equal to the period designated for analysis. In addition, the profile extractor 420 may extract the product amount during the analysis period as the total product amount based on the production information of the process line or the production information of each of the processes.

In operation 790, the profile extractor 420 may apply a statistical analysis technique to the information extracted in operation 780 and determine product statistical information using the average, standard deviation, maximum value, minimum value, etc. of the designated product.

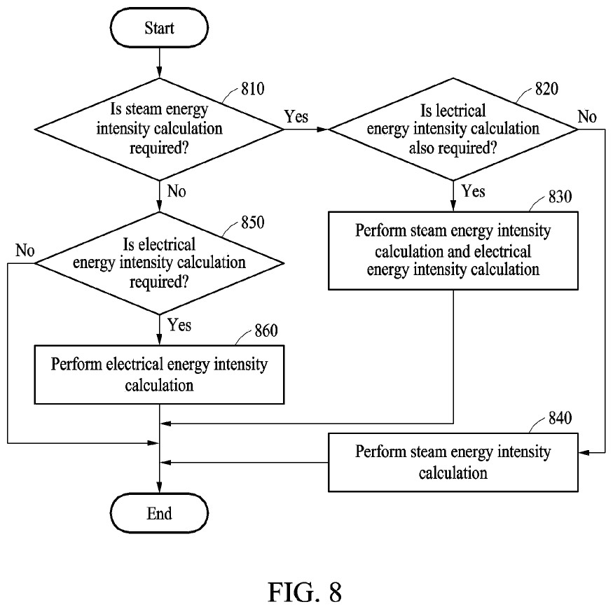

FIG. 8 is a flowchart illustrating a process of determining energy intensity per product of a method for analyzing stability of factory energy consumption, according to an embodiment.

As shown in FIG. 8, the intensity determiner 120 may select one or more of the energy types to determine whether to calculate the energy intensity per product of the energy source consumed to produce a certain product (i.e., the energy intensity per product for net production process), which is the energy intensity per product for a certain type of energy.

In operation 810, the intensity determiner 120 may determine whether steam energy intensity calculation is required. When the steam energy intensity calculation is required, the intensity determiner 120 may perform operation 820. In addition, the steam energy intensity calculation is not required, the intensity determiner 120 may perform operation 850. In operation 820, the intensity determiner 120 may determine whether electrical energy intensity calculation is also required. When the electrical energy intensity calculation is also required, the intensity determiner 120 may perform operation 830. In addition, when the electrical energy intensity calculation is not required, the intensity determiner 120 may perform operation 840.

In operation 830, the intensity determiner 120 may determine steam energy intensity by performing calculation of steam energy intensity and determine electrical energy intensity by performing calculation of electrical energy intensity.

In operation 840, the intensity determiner 120 may determine the steam energy intensity by performing the steam energy intensity calculation.

In operation 850, the intensity determiner 120 may determine whether the electrical energy intensity calculation is required. When the electrical energy intensity calculation is required, the intensity determiner 120 may perform operation 860. In addition, when the electrical energy intensity calculation is not required, the intensity determiner 120 may terminate the operation.

In operation 860, the intensity determiner 120 may determine the electrical energy intensity by performing the electrical energy intensity calculation.

Here, operations 830, 840, and 850 may be performed as detailed operations of operation 540 or operation 550.

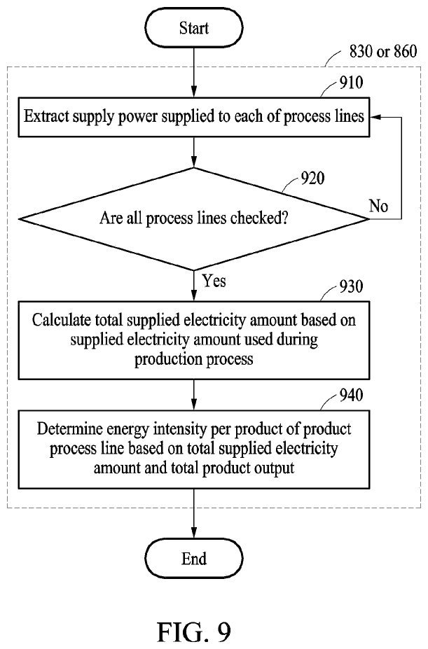

FIG. 9 is a flowchart illustrating a process of performing electrical energy intensity calculation for a process line in a process of determining energy intensity per product, according to an embodiment. Operations from 910 to 940 of FIG. 9 may be included in operation 830 or operation 860 of FIG. 8 performed as detailed operations of operation 540 of FIG. 5.

In operation 910, the intensity determiner 120 may extract electricity supply amount supplied to each of process lines.

In operation 920, the intensity determiner 120 may determine whether the supply power supplied to each of all process lines is extracted. When a process line from which the supply power is not extracted exists among the process lines, the intensity determiner 120 may perform operation 910. In addition, when the supply power for each of all process lines is extracted, the intensity determiner 120 may perform operation 930.

In operation 930, the intensity determiner 120 may calculate the total supply power for the process line based on the supply power used in each of the process lines during a normal operation period in which a process abnormality or a process interruption does not occur.

In operation 940, the intensity determiner 120 may determine the electrical energy intensity of the process line based on the total supply power of the process line and the total product amount.

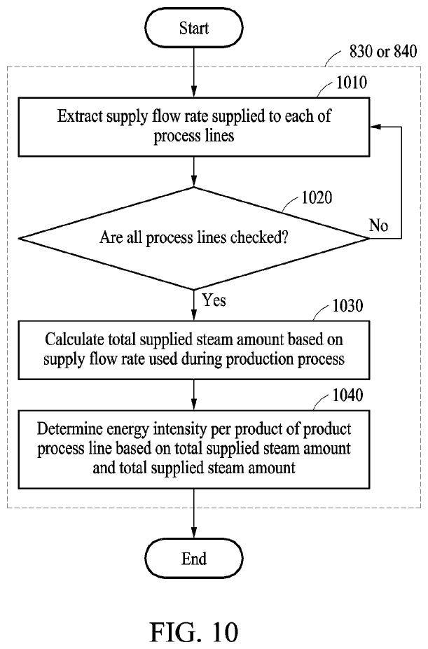

FIG. 10 is a flowchart illustrating a process of performing steam energy intensity calculation for a process line in a process of determining energy intensity per product, according to an embodiment. Operations from 1010 to 1040 of FIG. 10 may be included in operation 830 or operation 840 of FIG. 8 performed as detailed operations of operation 540 of FIG. 5.

In operation 1010, the intensity determiner 120 may extract a supply flow rate supplied to each of process lines to calculate steam consumption amount.

In operation 1020, the intensity determiner 120 may determine whether the supply flow rate supplied to each of process lines is extracted. When a process line from which the supply flow rate is not extracted exists among the process lines, the intensity determiner 120 may perform operation 1010. In addition, when the supply flow rate for each of process lines is extracted, the intensity determiner 120 may perform operation 1030.

In operation 1030, the intensity determiner 120 may calculate the total supplied steam amount for the process line based on the supply flow rate used in each of the process lines during a normal operation period in which a process abnormality or a process interruption does not occur.

In operation 1040, the intensity determiner 120 may determine the steam energy intensity of the process line based on the total supplied steam amount of the process line and total product amount.

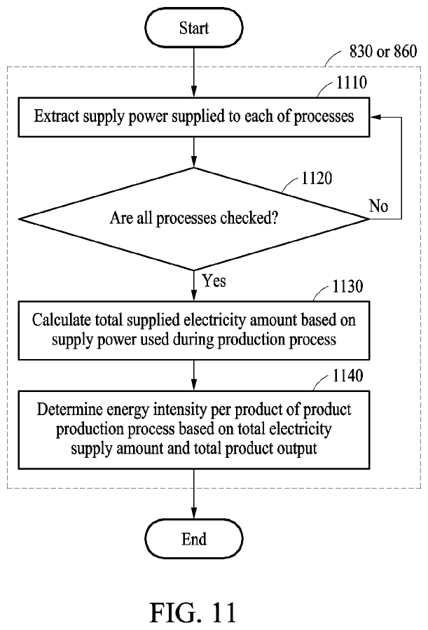

FIG. 11 is a flowchart illustrating a process of performing calculation of electrical energy intensity for each of processes in a process of determining electrical energy intensity per product, according to an embodiment. Operations 1110 to 1140 of FIG. 11 may be included in operation 830 or operation 860 of FIG. 8 performed as detailed operations of operation 550 of FIG. 5.

In operation 1110, the intensity determiner 120 may extract the electricity supply supplied to each of the processes in the process line.

In operation 1120, the intensity determiner 120 may determine whether the electricity supplied to each of processes is extracted. When a process from which the supplied electricity is not extracted exists among the processes, the intensity determiner 120 may perform operation 1110. In addition, when the supplied electricity for each of processes is extracted, the intensity determiner 120 may perform operation 1130.

In operation 1130, the intensity determiner 120 may calculate the total electricity supply amount for the process based on the supplied electricity used in each of the processes during a normal operation period in which a process abnormality or a process interruption does not occur.

In operation 1140, the intensity determiner 120 may determine the electrical energy intensity of the process based on the total electricity supply amount of the process and the total product amount.

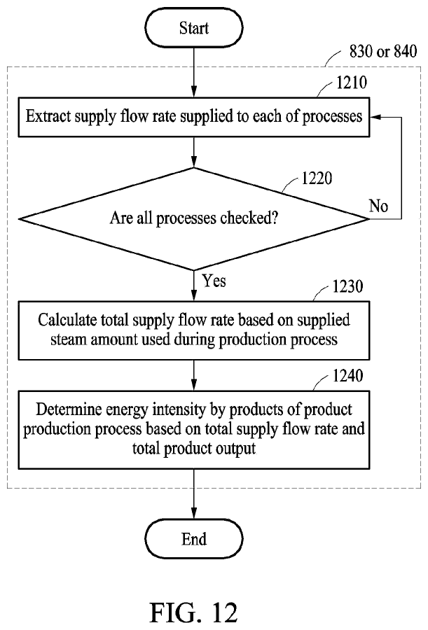

FIG. 12 is a flowchart illustrating a process of performing calculation of steam energy intensity for each of processes in a process of determining energy intensity per product, according to an embodiment. Operations from 1210 to 1240 of FIG. 12 may be included in operation 830 or operation 840 of FIG. 8 performed as detailed operations of operation 550 of FIG. 5.

In operation 1210, the intensity determiner 120 may extract a supply flow rate supplied to each of processes in a process line.

In operation 1220, the intensity determiner 120 may determine whether the supply flow rate supplied to each of processes is extracted. When a process from which the supply flow rate is not extracted exists among the processes, the intensity determiner 120 may perform operation 1210. In addition, when the supply flow rate for each of processes is extracted, the intensity determiner 120 may perform operation 1230.

In operation 1230, the intensity determiner 120 may calculate the total supplied steam amount for the process based on the supply flow rate used in each of the processes during a normal operation period in which a process abnormality or a process interruption does not occur.

In operation 1240, the intensity determiner 120 may determine the steam energy intensity of the process based on the total supplied steam amount of the process and the total product amount.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium.

The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned embodiments is required for all the embodiments, and it should be understood that the aforementioned program components and apparatuses may be integrated into a single software product or packaged into multiple software products.

The embodiments disclosed in the present specification and the drawings are intended merely to present specific examples in order to aid in understanding of the present disclosure, but are not intended to limit the scope of the present disclosure. It will be to apparent to one of ordinary skill in the art that various modifications based on the technical spirit of the present disclosure, as well as the disclosed embodiments, can be made.

What is claimed is:

1. A method of analyzing energy consumption stability, the method comprising:
extracting a profile comprising a production history of a product and process operation information of a process line or process equipment used to produce the product;
determining energy intensity per product, which is a ratio of an amount of energy consumed to produce the product, based on the profile; and
identifying consumption stability of energy consumed to produce the product based on the energy intensity per product.

2. The method of claim 1, further comprising:
performing pre-processing to extract the profile; and
setting a specific comparison period to generate comparative intensity to be compared with the energy intensity per product.

3. The method of claim 2, wherein the identifying of the consumption stability comprises determining comparative consumption energy intensity based on a profile extracted for the comparison period, comparing the comparative consumption energy intensity with the energy intensity per product, and identifying the consumption stability according to a comparison result.

4. The method of claim 2, wherein the performing of the pre-processing comprises:
selecting the product;
setting process hierarchy structure information for each process line that produces the product;
setting process-measurement point mapping information to extract measurement information collected from a point of an activity equipment or a processing machine designated as an analysis target in a process activity that produces the product; and
setting analysis time information, which is a time interval to extract the profile among pieces of time information from a time the product started to be produced to a time production of the product is completed.

5. The method of claim 1, wherein the extracting of the profile comprises:
extracting a production profile of a production period comprising a production history of the product;
determining whether production amount is measurable in the process line or each of processes;
extracting production information of the process line by measuring production of the process line when production amount is measurable in the process line;
extracting production information of each of the processes by measuring product amount of the process line when production amount is measurable in each of the processes; and
extracting product production amount during an analysis period as total amount for the designated product production based on the production information of the process line or the production information of each of the processes.

6. The method of claim 5, wherein the extracting of the profile further comprises:
determining whether a process interruption history exists during the production period based on the production profile;
extracting, as production information, information on a type of a product produced in the process line or the process equipment, a detailed specification of the product, and product amount of the process line or the process equipment during the production period, when the process interruption history does not exist; and
extracting, as production information, information on a type of a product produced in the process line or the process equipment, a detailed specification of the product, and product amount of the process line or the process equipment during a normal operation period in which a process abnormality or a process interruption does not occur, when the process interruption hi story exists.

7. The method of claim 1, further comprising:
determining whether steam energy intensity calculation for steam consumption is required;
determining whether electrical energy intensity calculation for electricity consumption is also required when the steam energy intensity calculation is required; and
determining whether the electrical energy intensity calculation for electricity consumption is required when the steam energy intensity calculation is not required,
wherein the determining of the energy intensity per product comprises determining at least one of steam energy intensity and electrical energy intensity by performing at least one of the steam energy intensity calculation and the electrical intensity calculation.

8. The method of claim 7, wherein the determining of the energy intensity per product comprises:
extracting a supply flow rate supplied to each of process lines when determining the steam energy intensity for the process line;
calculating a total supplied steam amount for the process line based on a supply flow rate used in each of the process lines during a normal operation period in which a process abnormality or a process interruption does not occur; and
determining the steam energy intensity of the process line based on the total supplied steam amount and of the process line and total product production amount.

9. The method of claim 7, wherein the determining of the energy intensity per product comprises:
extracting electricity supply supplied to each of the process lines when determining the electrical energy intensity for the process line;
calculating total electricity supply for the process lines based on electricity supply used in each of the process lines during a normal operation period in which a process abnormality or a process interruption does not occur; and
determining the electrical energy intensity of the process line based on the total electricity supply of the process line and total product production amount.

10. The method of claim 7, wherein the determining of the energy intensity per product comprises:
extracting a supply flow rate supplied to each of processes when determining the steam energy intensity for each of processes in the process line;
calculating a total supplied steam amount for the process based on a supply flow rate used in each of the processes during a normal operation period in which a process abnormality or a process interruption does not occur; and
determining the steam energy intensity of the process based on the total supplied steam amount of the process and total product production amount.

11. The method of claim 7, wherein the determining of the energy intensity per product comprises:
extracting supply electric power supplied to each of processes when determining the electrical energy intensity for each of processes in the process line;
calculating total supplied electricity amount for the process based on supply electric power used in each of the processes during a normal operation period in which a process abnormality or a process interruption does not occur; and
determining the electrical energy intensity of the process based on the total electricity supply of the process and total product production amount.

12. A system for analyzing stability of energy consumption, the system comprising:
a profile extraction module configured to extract a profile comprising a production history of a product and process operation information of a process line or process equipment used to produce the product;
an intensity determiner configured to determine energy intensity per product, which is a ratio of an amount of energy consumed to produce the product, based on the profile; and
an energy consumption instability identifier configured to identify consumption stability of energy consumed to produce the product based on the energy intensity per product.

13. The system of claim 12, wherein:
the profile extraction module is configured to set a comparison period to generate comparative intensity to be compared with the energy intensity per product, and
the energy consumption instability identifier is configured to determine comparative consumption energy intensity based on a profile extracted for the comparison period, compare the comparative consumption energy intensity with the energy intensity per product, and identify the consumption stability according to a comparison result.

14. The system of claim 12, wherein the profile extraction module is configured to:
extract a production profile of a production period comprising a production history of the product;
determine whether a process interruption history exists during the production period based on the production profile;
extract, as production information, information on a type of a product produced in the process line or the process equipment, a detailed specification of the product, and production amount of the process line or the process equipment, during the production period, when the process interruption history does not exist; and
extract, as production information, information on a type of a product produced in the process line or the process equipment, a detailed specification of the product, and production amount of the process line or the process equipment during a normal operation period in which a process abnormality or a process interruption does not occur, when the process interruption hi story exists.

15. The system of claim 12, wherein the intensity determiner is configured to:
determine whether steam energy intensity calculation is required and determine whether electrical energy intensity calculation is also required when the steam energy intensity calculation is required;
determine whether the electrical energy intensity calculation is required when the steam energy intensity calculation is not required; and
determine at least one of steam energy intensity and electrical energy intensity by performing at least one of the steam energy intensity calculation and the electrical energy intensity calculation.

16. The system of claim 15, wherein the intensity determiner is configured to extract a supply flow rate supplied to each of the process lines when determining the steam energy intensity for the process line, calculate a total supplied steam amount for the process line based on a supply flow rate used in each of the process lines during a normal operation period in which a process abnormality or a process interruption does not occur, and determine the steam energy intensity of the process line based on the total supplied steam amount of the process line and total product production amount.

17. The system of claim 15, wherein the intensity determiner is configured to extract supply power supplied to each of the process lines when determining the electrical energy intensity for the process line, calculate total electricity supply amount for the process line based on supply power used in each of the process lines during a normal operation period in which a process abnormality or a process interruption does not occur, and determine the electrical energy intensity of the process line based on the total electricity supply amount of the process line and total product production amount.

18. The system of claim 15, wherein the intensity determiner is configured to extract a supply flow rate supplied to each of processes when determining the steam energy intensity for each of processes in the process line, calculate a total supplied steam amount for the process based on a supply flow rate used in each of the processes during a normal operation period in which a process abnormality or a process interruption does not occur, and determine the steam energy intensity of the process based on the total supplied steam amount of the process and total product production amount.

19. The system of claim 15, wherein the intensity determiner is configured to extract supply power supplied to each of processes when determining the electrical energy intensity for each of processes in the process line, calculate total electricity supply for the process based on electricity supply used in each of the processes during a normal operation period in which a process abnormality or a process interruption does not occur, and determine the electrical energy intensity of the process based on the total electricity supply of the process and total product production amount.
